(19) United States
(12) Patent Application Publication
(10) Pub. No.: US 2007/0192367 A1
(43) Pub. Date: Aug. 16, 2007

(54) Generic expression framework for computer implementable expressions

(75) Inventors: Sreekar Choudhary, Bothell, WA (US); Pradyumna Siddhartha, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/355,710

(22) Filed: Feb. 16, 2006

(51) Int. Cl. G06F 17/00

(52) U.S. Cl. 707/104.1

(57) ABSTRACT

An expression framework for creating and executing computer implementable instructions using context elements is disclosed. The context elements are defined through the expression framework via expression tools. The expression framework is configured to generate a generic expression tree which utilizes the context elements to specify a translator for one or more nodes of the expression tree to provide multiple execution formats for the expression.

### BACKGROUND

Applications can operate in a multi-platform framework. For example, one business application may interface with another application or database. Different applications or databases can have their own custom execution formats or schedules. Typically, programmers or developers create expressions to implement different tasks or functions in different applications. For example in a business application, an expression or query can be used to retrieve all customer orders within a certain data range. In a multi-platform environment, implementation of the expression may require execution across multiple application platforms having multiple execution formats.

The discussion above is merely provided for general background information and is not intended to be used as an aid in determining the scope of the claimed subject matter.

### SUMMARY

An expression framework for creating and executing computer implementable instructions using context elements is disclosed. In embodiments disclosed, a translation context is used to specify a translator for a subplatform portion of an expression. The expression framework is configured to generate an expression tree which utilizes the context elements to implement the expression across multiple development or application platforms.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is an illustrative embodiment of a computing environment in which embodiments of an expression framework can be implemented.

FIG. 2 is a block diagram illustrating a multiple platform expression framework for a computer implementable expression.

FIG. 3 illustrates expression tools of the expression framework of FIG. 2 for creating expression elements.

FIG. 4 illustrates implementation of a multiple platform expression framework for designing and executing expressions.

FIG. 5 illustrates an embodiment of an expression tree including a plurality of expression nodes and associated contexts.

FIG. 6 illustrates design and run-time attributes of an embodiment of the expression framework.

FIG. 7 is a block diagram illustrating an embodiment of an object model framework for the expression framework.

FIG. 8 is a flow chart illustrating steps for defining and implementing a context based expression.

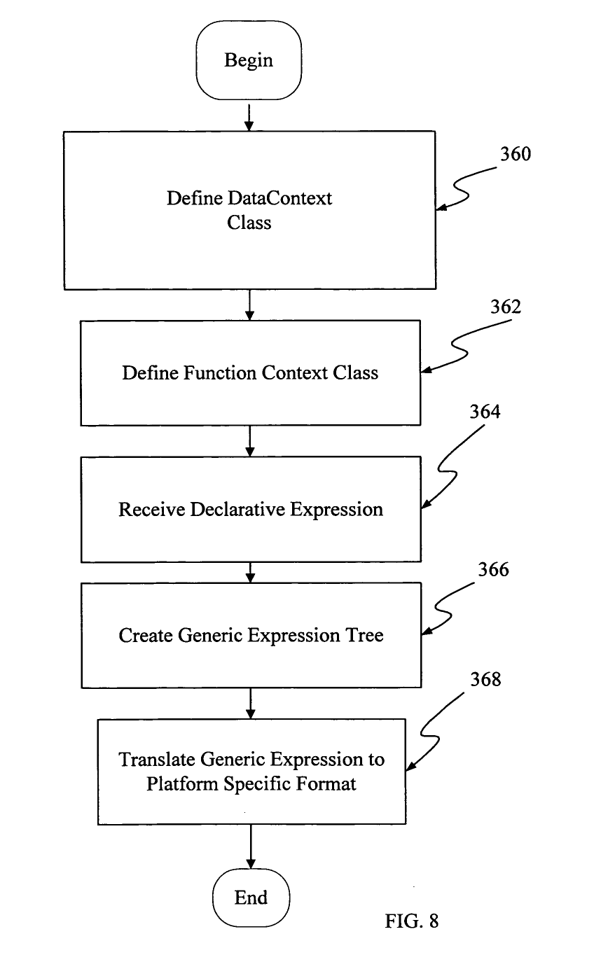

### DETAILED DESCRIPTION

The present application relates to an expression framework. However, prior to discussing the framework in greater detail, one embodiment of an environment in which the system or framework can be deployed will be discussed.

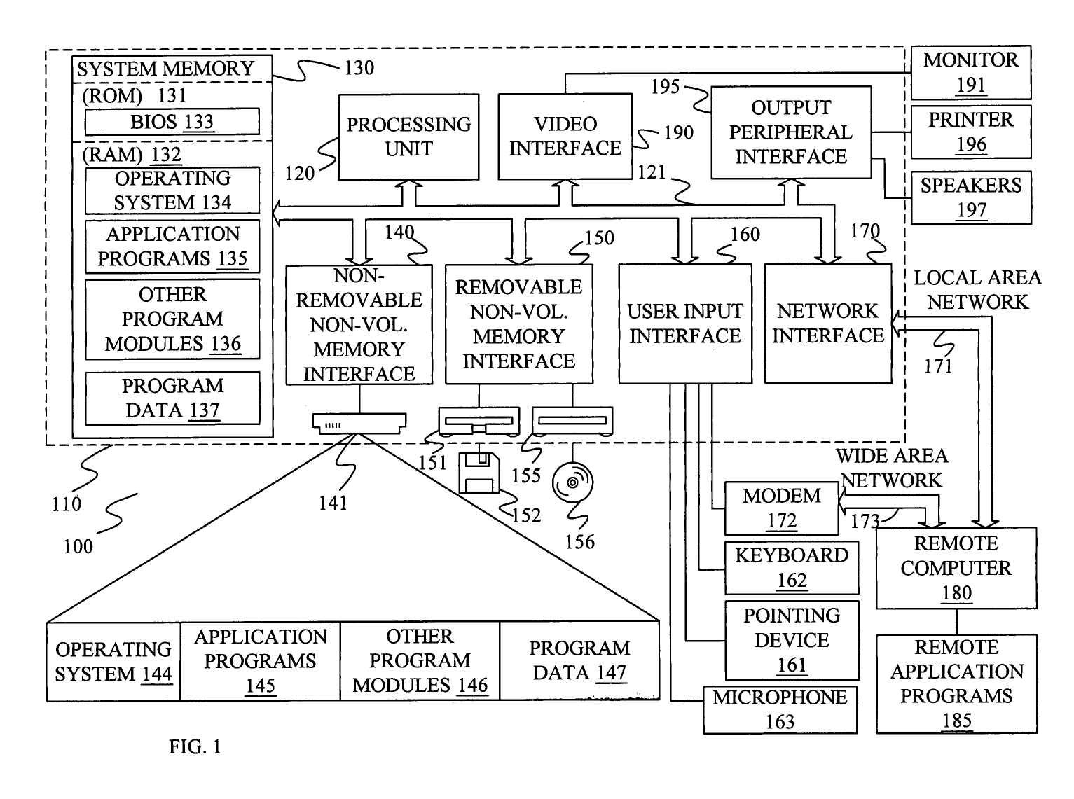

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purposes or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

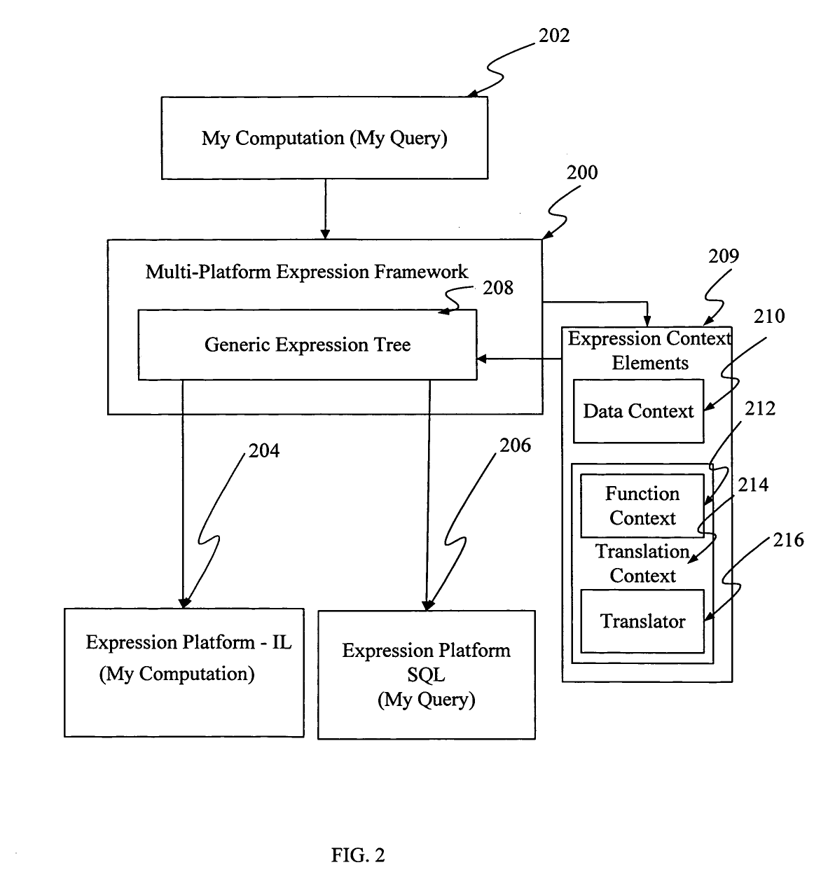

FIG. 2 illustrates a multiple platform expression framework 200 to design and execute computer implementable expressions 202. The illustrated framework 200 has application for the expression MyComputation (MyQuery) 202 including a MyComputation portion and a MyQuery portion that are executed in different expression platforms 204 and 206 using different language formats such as a Structured Query Language SQL or Intermediate Language IL. The expression framework 200 uses a generic expression 208 that refers to various context elements 209 to represent the expression tree. This expression tree can then be translated into multiple execution formats executable across different platforms. In the illustrated embodiment, the context elements 209 include a data context element 210, function context element 212 and an associated translator 216, which is associated through a translation context 214. Although particular context elements are described, application of the present invention is not limited to the specific context elements described.

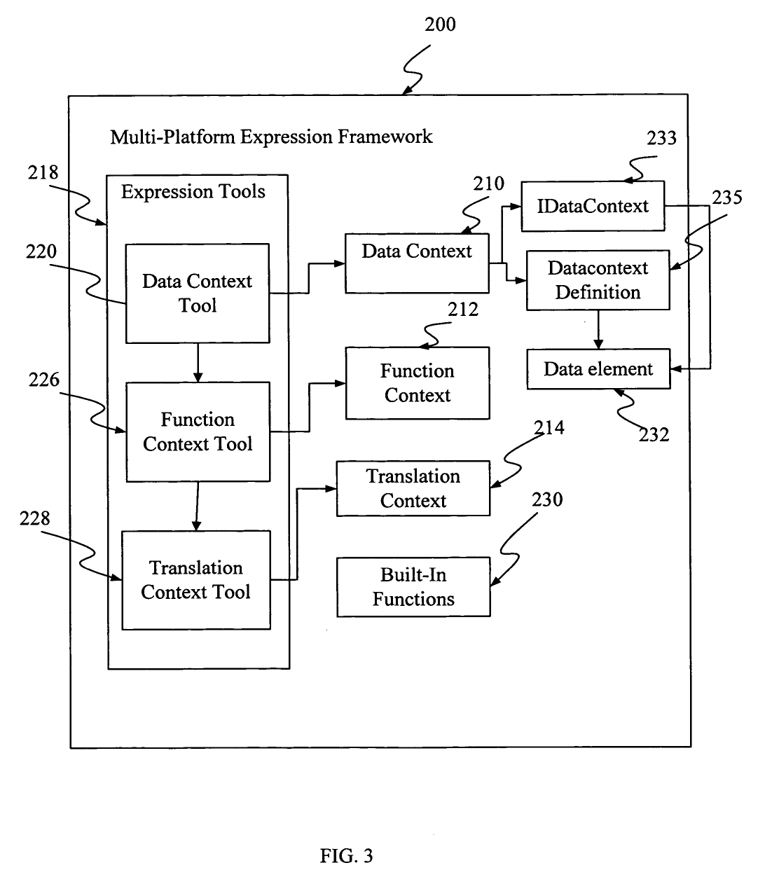

As shown in FIG. 3, the multi-platform expression framework 200 includes expression tools 218 that are invoked or called in a design-time environment to define the context elements 209. The expression tools 218 include a data context tool 220 to define data context element 210, a function context tool 226 for function context element 212 and a translation context tool 228 for plugging in translator 216. The framework 200 also includes a built-in function element 230. In an illustrated embodiment, the built-in functions of the expression framework 200 include common arithmetic functions (+, −, *, /), temporal, logical (AND, Or, NOT), relational (<, <=, >, >=, ==) and stringfunctions.

The data context element 210 represents data instances or data elements 232 that are available to the expression framework 200 including for example, global data elements and platform specific data elements. The data context element 210 has a design-time datacontextdefinition component 233 and a run-time data context IDataContext interface component 235.

The data context element 210 is created through the data context tool 220 by invoking a datacontextdefinition class 233 and implementing runtime methods (e.g. GetRuntimeType (object metadata). The methods retrieve types and validate paths for the dataelement 232 for the data context element 210. The data context element can be a global datacontext element that is available to all expressions, a caller data context element available to a single expression or a temporary or local data context element declared within the expression. The data context tool 220 adds, updates or remove data instances to be used in the expression using predefined function options including AddData (string key, DataElement entry), UpdateData (string key, DataElement entry) and RemoveData (string key).

The function context tool 226 defines expression functions for the expression framework 200. The function context elements 212 are created by instantiating a function context class and adding or removing a function using an option AddFunction (Type functionType, MethodInfo method) and option RemoveFunction (Type functionType, MethodInfo method). The default constructor for the function context already contains the logical, temporal, string and relational functions.

The translation context tool 228 includes options or methods for creating the translation context 214 to associate a translator 216 with a function context 212. The translator type specified can be a managed translator or custom translator for a particular execution format.

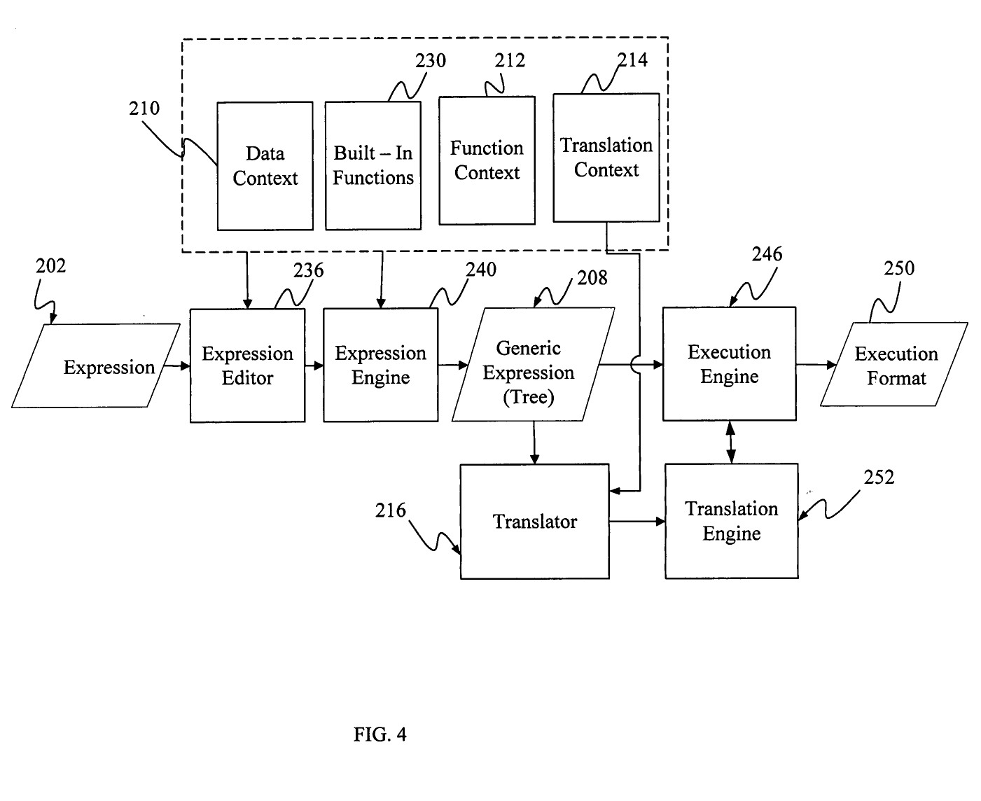

As shown in FIG. 4, the expression framework 200 includes an expression editor 236 to formulate text expression 202. The expression editor 236 invokes a user interface UI that allows a user to input text expression 202 in a design environment. In an illustrative embodiment, the UI is configured to allow the user to build expressions 202 using drag and drop type UI features. The data context element 210, built in functions 230 and function context element 212 provide lists of objects or data instances to the expression editor 236 to define expression elements that can be used to create expressions 202.

Expressions are passed to an expression engine 240 to generate the generic expression tree 208 utilizing instances or objects of the data context, function context and translation context elements 210, 212, 214. The tree 208 is passed to an execution engine 246 to generate a platform specific execution format or structure 250. The execution engine 246 groups nodes of the tree by execution format and then translates and executes subtrees under the chosen node or nodes.

The expression or portions of the expression (sub trees) are translated by a translation engine 252 based upon translator 216. Translation of the expression or portions of the expression is determined based upon the translation context 214. The translator engine 256 can be accessed as a plug-in component of the expression framework.

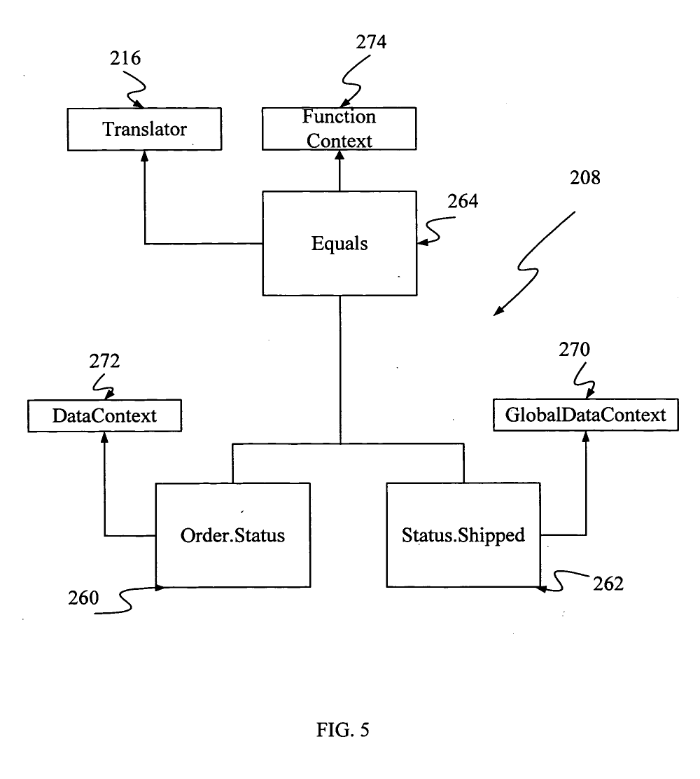

FIG. 5 illustrates a generic expression tree 208 for the text expression Order.Status==Status.Shipped. As shown, the expression tree 208 includes expression nodes 260, 262 for order.status and status.shipped and a hierarchical expression node 264 for the equal function. The status.shipped node 262 of the expression tree 208 includes an association to a global data context element 270 and the order.status node 260 includes an association to a data context element 272. The equal function node 264 has an associated function context 274 and translator 216, which is associated with the equal function node 264 based upon the associated translation context for the function context 274. The data context and function context elements are used to implement platform specific functions and data instances and calls.

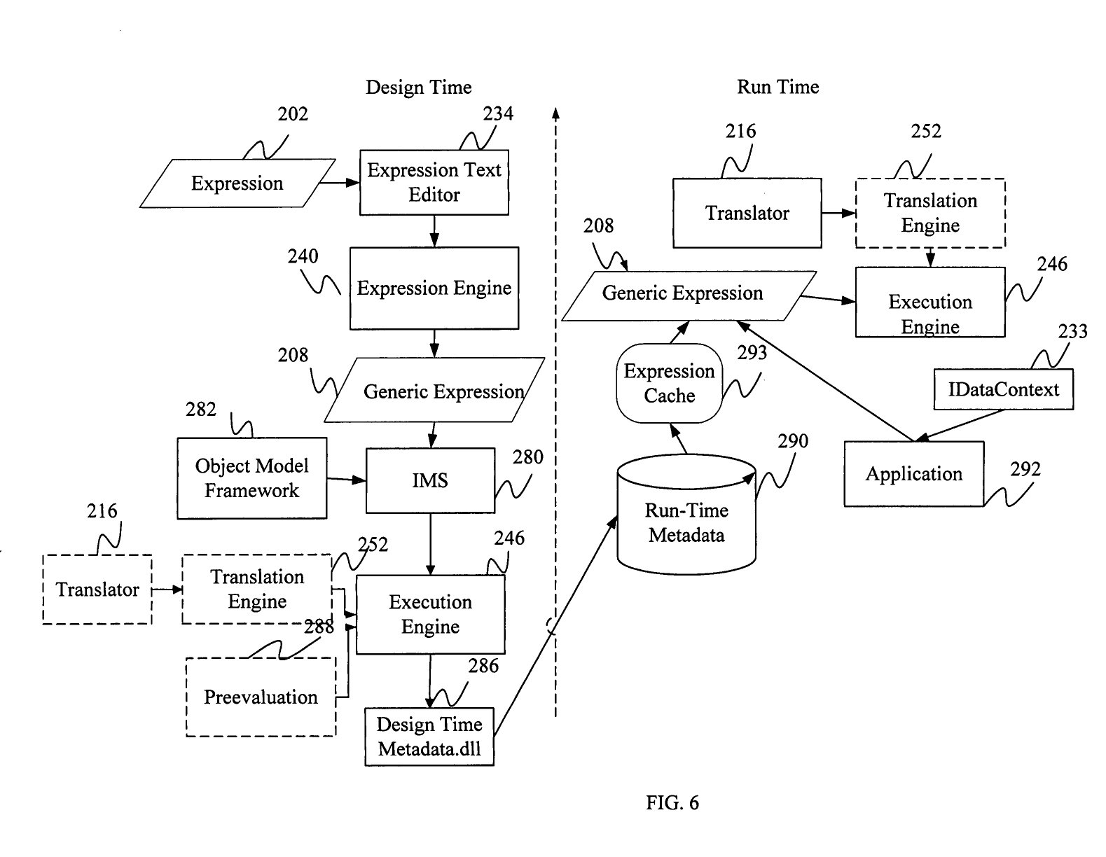

The multiple platform expression framework 200 is used by developers or programmers to design and model expression in a design environment which are invoked or called in a run-time environment. FIG. 6 illustrates design time and run-time attributes of an embodiment of the expression framework 200. As shown in FIG. 6, the expression engine 240 defines a generic expression tree 208 for a declarative expression using context elements 209 and tools 218 as previously described.

The generic expression 208 is used to create an object model or intermediate management system IMS 280 based upon an object model framework 282. The expression is processed and validated by the execution engine 246 to create design time metadata (metadata.dll) 286 for the expression. In the design time environment, the execution engine 246 can preevaluate nodes of the expression as illustrated by preevaluate component 288 or the execution engine 246 can translate and/or validate portions of the expression tree depending upon implementation of the execution engine 246.

Design time metadata 286 is deployed to a run-time metadata store 290 for use by an application program 292 such as an accounting or business application. The translated expression can be cached as a blob 293 that can be deployed along with the expression object model at run time. At run-time, the expression is invoked by the application program 292 from run-time metadata 290. In the embodiment shown, actual instances of the data element 232 corresponding to the datacontext definition 235 are invoked through IDataContext interface 233. The expression is passed to the execution engine 246 and the expression or portions of the expression are evaluated and translated by the translation engine 252 based upon translator 216. During run-time, different execution structures can be created by specifying different translators and portions of the expression tree re-evaluated and translated based upon the translator 216 specified.

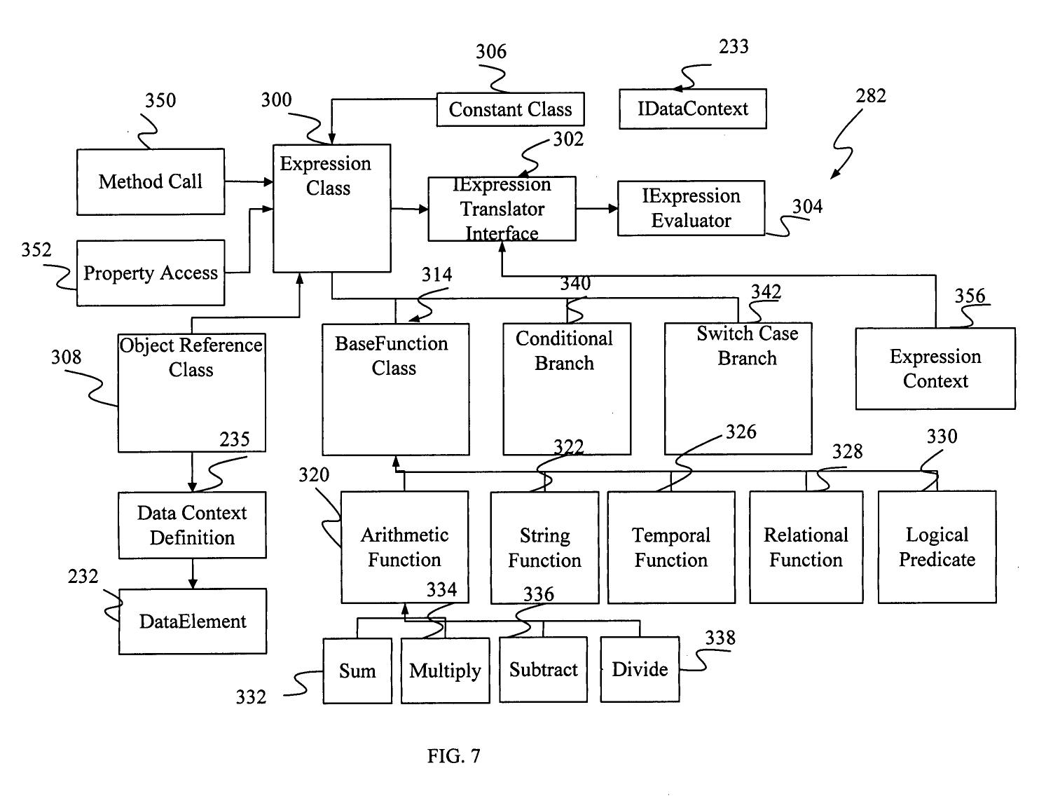

FIG. 7 illustrates an embodiment of the object model framework 282 to build an object model for execution of an expression. As shown, the object model framework 282 includes an abstract expression class 300. The expression class 300 represents a single node in the expression tree and includes an association to an Iexpression translator 302 and Iexpression evaluator 304 interface classes.

The data part of the expression can include constant class 306 or an ObjectReference class 308. The constant class 306 is used to represent a constant (literal) and includes a value and a type. An ObjectReference 308 is used to represent variables that are defined in the DataContextDefinition 235. The object reference contains a DataContext Definition 235 and a key which can be used to retrieve a DataElement 232 from the DataContextDefinition 232. The DataElement 232 is used to get the type and metadata for the object during design time to validate its use and is modeled as binding in metadata. At runtime, this binding can be resolved to a value by the expression framework 200 through IDataContext 233 as previously described.

The function part of the expression is represented by a BaseFunction class 314 and can either be a Built-In Function (e.g. Add)) or function defined by the function context element 212. The user can create function vocabulary for an expression and write a class in code that inherits from the BaseFunction 314 or one of its subclasses. In the illustrated embodiment subclasses of the base function 314 include arithmetic functions 320, string functions 322, temporal functions 326, relational functions 328, and logical predicate 330. Subclasses of the arithmetic function 320 include sum 332, multiply 334, subtract 336 and divide 338.

The class structure under BaseFunction determines the categorization of functions, both in terms of UI and for validation purposes. Functions and/or pure categories should be able to implement a valid method that determines whether or not a particular implementation matches certain predetermined rules for how the function should look in terms of parameters and return type. An expression can also be a simple conditional branch 340 (“IF expression THEN expression ELSE expression”) or a Switch-Case branch 342.

The object model framework 282 includes PropertyAccess 350 and MethodCall classes 352 to access properties on the target expression (e.g. customer.Address.Zip) or call methods on the expression or portions of the expression (e.g. Customer.GetOrder(orderId)) or traverse through a mix or properties and methods starting from a root target expression.

The object model includes an expression context 356. The expression context 356 defines and creates platform specific instances of the Iexpression translator interface 302 for platform specific functions and data. The Iexpression translator as well as other elements of the expression context can be defined and applied to the expression tree at design time or run-time as defined in FIG. 6. Thus, the translator interface 302 can be late bound or early bound depending upon implementation. Data variables can also be early or late bound depending upon the implementation.

The expression or parts of the expression can be translated at design time or at run time. The parts of the expression translated at run-time can use pre-evaluated values cached from designed time using a managed evaluation format. The expression context 356 defines portions for managed evaluation through an Iexpression element.

During run-time, the expression is executed and portions of the expression marked for late binding are translated by translation engine 252. For translation, the subplatform exposes the objects to expressions system referred to during designed time through the IDataContext interface 233. The IDataContext interface 233 includes methods GetValue (string, key) and SetValue (string, key, object value) to retrieve data elements defined during design time for late bound variables.

Expression can also be created at runtime using a runtime application program interface that creates an expression object model. The expression platform described can be implemented using multiple or different expression systems or development applications including C# and .NET framework expression objects and functionality. In the present application, managed or native refers to .NET framework based code.

FIG. 7 illustrates steps for creating an expression using the multiple platform framework 206 as previously described. As shown in steps 360 and 362, data context or function context classes are created or defined for formulating a declarative expression. As shown in step 364, the declarative expression is received and a generic expression tree is created in step 366. The generic expression tree is translated to an execution format as illustrated in step 368.

Application of an embodiment of the expression framework is illustrated in the following example for the expression or query:

((Order.Customer.Salesperson.ID==CurrentSalesPerson. ID)//

Resembles(Order.Customer.SalesPerson.Name,Current SalesPerson.Name)) &&

(Order.Date>Today−30)

to find sales orders for a particular salesperson within the last 10 days.

In the illustrated example, a portion of the expression e.g. Today−30 can be natively evaluated (using a managed translator), and the rest of the expression is translated to a SQL query (e.g. the translator translates the ‘Resemble( )’ function to a SQL ‘Like’ keyword that is executed on an SQL server).

In the illustrated expression an “Order” variable of type ‘Order’ is added to the DataContextDefinition of the expression framework using, “Order” and typeof(Order) as the <Key, Value> pair. This makes the “Order” variable available for use in the expression.

The variable “currentOrder” is not natively evaluated-since it needs to be sent to the SQL Server, hence translation information is added to the translation context linking this DataContext Definition entry to Translator T1 (which is a subplatform SQL translator). As a result, any expression node (of type ObjectReference) that refers to the “currentOrder” variable is marked to use Translator T1.

The Expression Framework Adds the “currentSalesPerson” variable of type ‘SalesPerson’ to the DataContext Definition 233 using <“currentSalesPerson”, typeof(SalesPerson)> as the <Key, Value> pair. This makes the “currentSalesPerson” variable available for use in the expression. The expression framework 200 evaluates “currentSalesPerson” using a managed evaluator, hence no translator is specified for this DataContextDefinition entry. As a result, any expression node (of type ObjectReference) that refers to the “currentSalesPerson” variable is marked for managed evaluation. (Note: CurrentSalesPerson is a MeAssociation on the CurrentUser). The expression subplatform adds an actual SalesPerson instance to the DataInstanceContext at runtime, as IDataContext 233, otherwise the managed evaluation will fail.

‘Today’ is a Built-In temporal function (inheriting from TemporalFunction class). ‘Today’ can be preEvaluated or evaluated on the SQL Server, in which case a ‘RemoteToday’ keyword is added to the function context 212.

The vocabulary of the expression framework 200 is extended by adding the ‘Resembles’ keyword. The framework registers the ‘Resembles (string, string)’ MethodInfo with the function context element 212. The ‘Resembles( )’ function is not pre-evaluated and it is translated to the SQL Server ‘LIKE’ keyword and evaluated on the SQL Server. Translator T1 (which will translate resembles to ‘LIKE’ is associated with the ‘Resembles ( )’ method. Since the ‘Resembles( )’ method is never pre evaluated, the ‘Resembles (string, string)’ MethodInfo can be a dummy implementation.

The “==”, “>”, “&&” and “−” are all built-in operators and thus, are pre-defined by the expression framework 200.

Once the vocabulary for the variables and functions are available, the user can enter the above expression. Portions of this expression (CurrentSalesPerson.ID, Today−30, CurrentSalesPerson.Name) are marked for managed evaluation as discussed and the remaining Expression is marked for translation using the Platform or SQL Translator T1. For each managed evaluation a method call is generated and packaged at the root of the sub tree (marked for managed evaluations) in the expression object model.

Deployment moves the expression tree to the runtime as previously discussed. At runtime, the expression framework 200 implements IDataContext 233 and adds the actual SalesPerson instance to expression. At runtime, a call to evaluate the expression is made. The managed evaluator will evaluate the relevant portions of the expression. After managed evaluation the expression can become:

((current.Order.Customer.SalesPerson.ID==“J12”)//

Resembles

(currentOrder.Customer.SalesPerson.Name, “John”)) && currentOrder.Date>“June18”,

since J12, June18 and John are added at runtime. The managed evaluation does not prune the expression tree; it only caches the evaluated values at relevant nodes.

The natively evaluated expression is sent to the subplatform translator T1 which translates the expression to the appropriate SQL Where clause (e.g. the ‘Resembles’ function is translated to the ‘LIKE’ keyword). The translated expression forms a T-SQL where clause and is evaluated by SQL Server.

In another example for the text expression:

Customer.CreditScore.Editable:Customer. Address.Country==“US”&&CurrentUser.Role.Name==“MBFPowerUser” where a customer entity has a credit score that is editable only if the customer lives in the United States and the current user belongs to MBF PowerUser role

The expression framework adds the “customer” variable of type ‘Customer’ to the DataContextDefinition 235 using <“customer”, type of (Customer)> as the <Key, Value> pair. This makes the “customer” variable available for use in the expression. The expression framework 200 wants any reference to “currentSalesPerson” to be natively evaluated hence no translator is specified for this DataContextDefinition entry. As a result, any expression node (of type ObjectReference) that refers to the “customer” variable is marked for managed evaluation. The expression framework 200 must add an actual Customer instance to the DataInstanceContext 235 at runtime, otherwise this managed evaluation will fail.

The literal “US” and the literal “MBFPowerUser” are represented by instance of the ‘constant’ class in the expression object model. The “currentUser” variable is present in the GlobalDataContext and is available to all expression platforms. The “==”, “&&” are Built-In Operators and thus are available to the expression framework 200.

Again, once the vocabulary is defined, the user enters the above expression. In the above example, the entire expression is marked for managed evaluation. A single method that implements the tree is created and compiled.

Deployment moves the expression tree to the runtime. At runtime, the expression platform implements IDataContext 233 and adds the actual customer instance to the expression. At runtime, a call to evaluate the expression is made. The managed evaluator will be able to evaluate the entire expression.

Although the subject matter has been describe in language specific to structural features and/or methodological acts, it is be to understood that the subject matter defined in the appended claims is not necessarily limited to the specific features or acts described above. Rather, the specific features and acts described above are disclosed as example forms of implementing the claims.

What is claimed is:

1. An expression framework executable on a computer readable medium comprising:
an expression engine having computer implementable instructions configured to receive an input expression and generate an expression tree including a plurality of expression nodes; and
a context element or elements configured to associate one or more of the plurality of expression nodes with a translator to convert the one or more of the plurality of expression nodes into a computer implementable execution format.

2. The expression framework of claim 1 including a translation context to associate the one or more nodes of the expression tree with the translator.

3. The expression framework of claim 2 wherein the context element or elements include a data context element or function context element and the expression engine is configured to associate the data context element or function context element to data or function nodes of the expression tree.

4. The expression framework of claim 3 wherein the translation context associates the translator to the one or more of the plurality of expression nodes based upon the function context element associated with the one or more of the plurality of expression nodes.

5. The expression framework of claim 3 wherein the translation framework invokes expression tools to create the data context element or function context element to define data elements or functions for the expression framework.

6. The expression framework of claim 3 wherein the data context element is one of a global data context, a caller data context or a local data context.

7. The expression framework of claim 3 and further comprising an expression editor that interfaces with the data context element or function context element of the expression framework to provide a list of functions or data elements for the expression framework.

8. The expression framework of claim 1 and further comprising an execution engine configured to invoke a translation engine to translate portions of the expression tree wherein the portions of the expression tree are translated at design time or run-time.

9. The expression framework of claim 1 and further comprising an expression context to define a translator interface for the translator associated with the one or more of the plurality of nodes on the expression tree.

10. The expression framework of claim 9 wherein the translator interface is defined at design-time or run-time.

11. The expression framework of claim 3 wherein a data context definition for the data context element is defined at design time and an instance of the data element for the data context definition is invoked at run-time.

12. A method executable on a computer readable medium having stored thereon computer executable instructions for implementing the steps of:
receiving an input expression; and
generating a generic expression tree for the input expression including a plurality of expression nodes and one or more of the plurality of expression nodes having a translation context associated therewith to define a translator to translate the one or more of the plurality of expression nodes into multiple execution formats.

13. The method of claim 12 and further comprising the step:
translating portions of the expression tree into different execution formats.

14. The method of claim 13 and comprising the step of translating portions of the expression tree in one or both of a design time environment or a run-time environment.

15. The method of claim 12 and comprising the step of:
specifying the translator for the one or more of the plurality of expression nodes at run-time.

16. The method of claim 12 wherein one or more of the plurality of expression nodes is associated with a data context element and further comprising the step of:
specifying an instance of a data element of the data context element at run-time.

17. The method of claim 12 wherein one or more of the plurality of expression nodes is associated with a function context element or a data context element and the translation context is determined based upon the function context element.

18. A computer readable medium having stored thereon an expression tree including:
a plurality of expression nodes; and
a translation context associated with one or more of the plurality of expression nodes.

19. The computer readable medium of claim 18 and further comprising a function context element or data context element associated with the one or more of the plurality of expression nodes.

20. The computer readable medium of claim 19 wherein the translation context is associated with the one or more of the plurality of expression nodes based upon the function context element associated with the one or more of the plurality of expression nodes.
